(19) United States
(12) Patent Application Publication
(10) Pub. No.: US 2024/0365763 A1
(43) Pub. Date: Nov. 7, 2024

(54) SOFT PLASTIC FISHING LURE WITH ATTRACTING INSERT

(71) Applicant: RBM JIGS L.L.C., Cedar Springs, MI (US)

(72) Inventor: Matthew Goehler, Cedar Springs, MI (US)

(73) Assignee: RBM JIGS L.L.C., Cedar Springs, MI (US)

(21) Appl. No.: 18/653,563

(22) Filed: May 2, 2024

Related U.S. Application Data
(60) Provisional application No. 63/499,512, filed on May 2, 2023.

(51) Int. Cl. A01K 85/00; A01K 85/01

(52) U.S. Cl. CPC A01K 85/1847; A01K 85/015; A01K 85/017; A01K 85/018; A01K 85/1811

(57) ABSTRACT

A soft plastic fishing lure has a bait body with a head portion and a tail portion opposite the head portion. The bait body has an elastomeric material and defines a cavity with an opening disposed at the tail portion. The cavity extends into the bait body toward the head portion. An insert is configured to be inserted into the cavity through the opening and retained in the bait body. The insert has a fish attracting feature, such as a rattle, a glow stick, or a scented material.

### CROSS-REFERENCE TO RELATED APPLICATION

This application claims benefit and priority under 35 U.S.C § 119 (e) to U.S. Provisional Patent Application No. 63/499,512, filed May 2, 2023, the disclosure of which is considered part of this application and is hereby incorporated by reference in its entirety.

### TECHNICAL FIELD

The present disclosure relates generally to fishing lures and artificial bait for angling and more specifically relates to elastomer-based lures and artificial bait.

### BACKGROUND

It is well known for anglers to fish with lures and bait made of artificial materials, like rubber, metal, and plastic materials. These artificial materials can be used to imitate live bait, target certain species of fish, and accommodate different fishing environments, such as murky water, low light conditions, heavy plant growth, or the like. For example, spoons and spinner bait are designed with shapes and materials to provide certain movements and noises that attract fish. Some lures made with rigid materials provide integrated hooks or eyelets that receive hooks. In other instances, elastomer-based lures are pierced with hooks by the angler and are frequently referred to as soft plastic bait or simply soft plastics. Typically, elastomer-based lures are molded to resemble a live creature often used as fishing bait, such as grubs, worms, minnows, or the like. Various types of fishing hooks are used with elastomer-based lures and are pierced through different sections of the elastomer-based lure.

### SUMMARY

This disclosure provides a soft plastic fishing lure that has a preformed cavity in the bait body that is designed to receive an insert with a fish attracting feature, which may be selected to be desirable for the angler's perceived fishing conditions. For example, the insert may include a rattle with the fish attracting feature being the emission of sound waves from the rattle. In another example, the insert may include a glow stick with the fish attracting feature being the emission of light waves from the glow stick. In yet another example, the insert may include a scented material with the fish attracting feature being the emission of the chemical attractant from the scented material. The angler may select a desirable insert and insert it in the cavity of the elastomeric bait body to customize the soft plastic fishing lure to target certain species of fish and/or accommodate different fishing environments.

One aspect of the disclosure provides a soft plastic fishing lure that has an elongated bait body formed from an elastomeric material. The elongated bait body has an interior cavity with an opening extending from an exterior of the bait body into the interior cavity. An insert is configured to be inserted into the cavity through the opening and retained in the bait body. The insert has a fish attracting feature, such that the fish attracting feature may be configured to emit at least one of light waves, sound waves, or a chemical attractant. In some examples, the insert includes a rattle, a glow stick, or a scented material.

In some implementations, the insert includes an elongated shape that, when inserted in the bait body, extends longitudinally within the cavity. In some examples, the insert includes a rigid material with a higher durometer than the bait body, such that the stiffness of the insert allows it to be more easily inserted and removed from the cavity.

The cavity, in some implementations, extends longitudinally within the bait body. In some examples, the cavity may include a bulbous section toward a head portion of the bait body and a narrow section between the bulbous section and the opening of the cavity. For example, the narrow section may have a diameter less than the insert in the bulbous section, such that the narrow section may elastically expand for inserting or removing the insert and may elastically contract to retain the insert in the bulbous section during use of the fishing lure.

In additional implementations, the bait body includes an upper area and a lower area divided along a longitudinal axis of the bait body. The upper area may have a vertical thickness that is greater than a diameter of the cavity. In some examples, a hook may be pierced in the upper area of the bait body above the cavity, such as not to pierce or intersect the cavity.

In other implementations, the bait body includes a head portion and a tail portion located longitudinally relative to each other. The opening of the cavity may extend into the bait body toward the head portion. The head portion and tail portion may refer to the longitudinal direction in which the bait body is configured to be pulled through the water, with the head portion leading through the water. Moreover, the bait body may be molded in the shape of a minnow, a worm, a frog, or a crayfish, which may also have the anatomical shape that corresponds to the respective head portion and tail portion of the bait body.

Another aspect of the present disclosure provides a soft plastic fishing lure having an elongated bait body comprised of an elastomeric material. The elongated bait body has a hollow cavity disposed along a length of the elongated bait body with an opening extending from an exterior of the bait body into the hollow cavity. An insert having a fish attracting feature is configured to be inserted into the cavity through the opening and retained in the bait body.

A further aspect of the present disclosure provides a soft plastic fishing lure having a bait body with a head portion and a tail portion opposite the head portion. The bait body comprises an elastomeric material. The bait body defines a cavity with an opening disposed at the tail portion and extending into the bait body toward the head portion. An insert is configured to be inserted into the cavity through the opening and retained in the bait body, where the insert has a fish attracting feature.

Each of the above independent aspects of the present disclosure, and those aspects described in the detailed description below, may include any of the features, options, and possibilities set out in the present disclosure and figures, including those under the other independent aspects, and may also include any combination of any of the features, options, and possibilities set out in the present disclosure and figures.

The details of one or more implementations of the disclosure are set forth in the accompanying drawings and the description below. Other aspects, advantages, purposes, and features will be apparent upon review of the following specification in conjunction with the drawings.

### BRIEF DESCRIPTION OF THE DRAWINGS

FIG. 1 is a side view of a soft plastic fishing lure having an insert with a fish attracting feature.

FIG. 2 is a bottom view of the soft plastic fishing lure shown in FIG. 1.

FIG. 3 is a side cross-sectional view of the soft plastic fishing lure taken at line III-III shown in FIG. 2.

FIG. 4 is side view of a soft plastic fishing lure with a cavity for an insert.

FIG. 5 is bottom view of the soft plastic fishing lure shown in FIG. 4.

FIG. 6 is a side cross-sectional view of the soft plastic fishing lure taken at line VI-VI shown in FIG. 5.

FIG. 7 is side view of the soft plastic fishing lure shown in FIG. 4 with a rattle insert partially inserted in the cavity.

FIG. 8 is bottom view of the soft plastic fishing lure shown in FIG. 7 with the rattle insert fully inserted in the cavity.

FIG. 9 is a side cross-sectional view of the soft plastic fishing lure taken at line IX-IX shown in FIG. 8.

FIG. 10 is side view of a soft plastic fishing lure having a glow insert in the cavity.

FIG. 11 is bottom view of the soft plastic fishing lure shown in FIG. 10.

FIG. 12 is bottom view of the soft plastic fishing lure shown in FIG. 11 with the glow insert partially removed from the cavity.

FIG. 13 is bottom view of the soft plastic fishing lure shown in FIG. 11 with the glow insert removed from the cavity.

FIG. 14 is bottom view of another example of a soft plastic fishing lure having an insert in a cavity.

FIG. 15 is bottom view of another example of a soft plastic fishing lure having an insert in a cavity.

Like reference numerals indicate like parts throughout the drawings.

### DETAILED DESCRIPTION

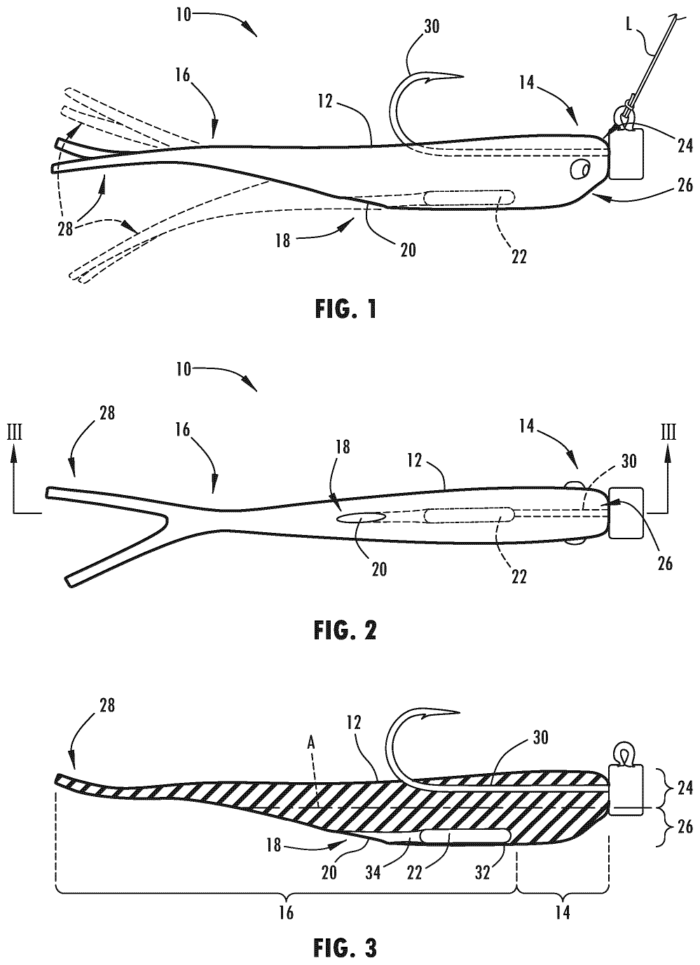

Soft plastic fishing lures are disclosed herein in various implementations as artificial baits that are used in conjunction with other fishing tackle and equipment to attract various fish species or other aquatic species to bite the bait and ultimately successfully catch the fish or other aquatic species. For example, a fishing pole may be used by an angler with a rod and reel having a spool of fishing line that leads away from the spool through the eyelets along the rod and beyond a distal end of the rod to attach directly or indirectly to fishing lure. For instance, the fishing line L may be tied to a hook 30 that is directly engaged with the bait (FIG. 1) or may attach to various additional leaders or other tackle that is then engaged with the bait. The fishing poles and tackle used with the disclosed soft plastic fishing lure may vary widely for different fishing preferences, targeted species, and fishing conditions.

Referring to FIGS. 1-3, a soft plastic fishing lure 10 is illustrated having an elongated bait body 12 formed from an elastomeric material, which can be referred to as a soft plastic material. The bait body 12 is formed in the shape of a minnow with a head portion 14 and a tail portion 16 opposite the head portion 14. As referred to herein, the head portion 14 of the bait body 12 is located at front end of the bait body 12 and the tail portion 16 is located rearward of the front end of the bait body 12, where the front end is defined as the leading end that is pulled through the water by the fishing line L ahead of the rear end of the bait body 12. In this example, the head portion is also defined by the anatomical head of the minnow. Similarly, the tail portion is defined by the anatomical tail of the minnow. In other examples, the bait body may be molded in the shape of tube or other non-anatomical shape or may be molded in the anatomical shapes of a worm, a frog, or a crayfish, or the like.

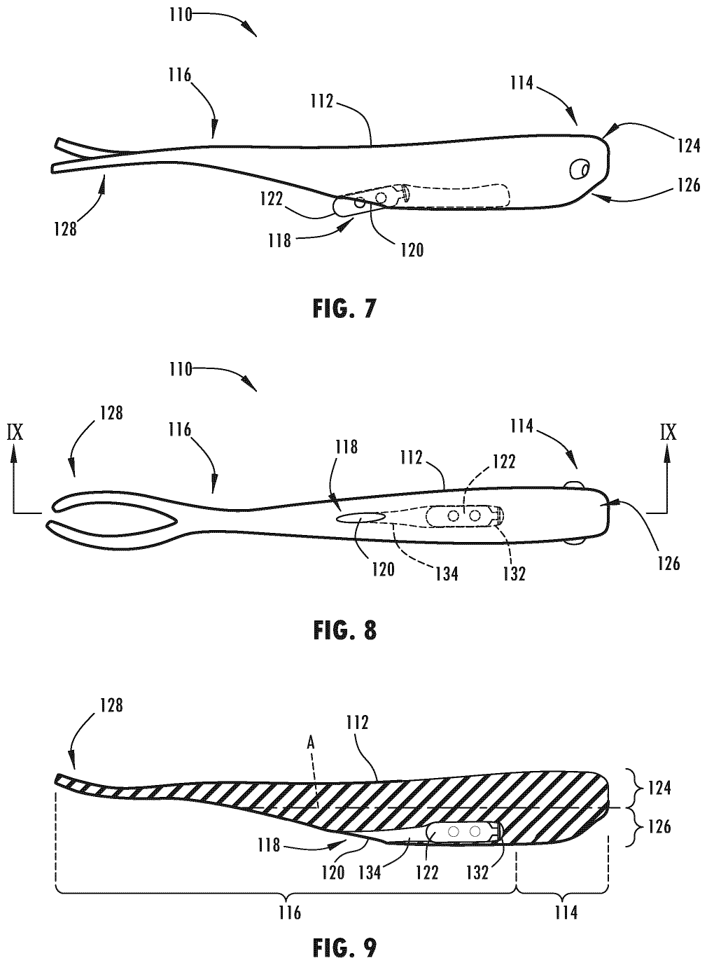

As also shown in FIGS. 1-3, the bait body 12 defines a cavity 18 with an opening 20 facing rearward and disposed generally at the tail portion 16. The cavity 18 extends into the bait body 12 toward the head portion 14. An insert 22 is configured to be inserted into the cavity 18 through the opening 20 and retained in the bait body 12. The insert 22 may also be removable from the cavity 18 through the opening 20, such as to allow a different insert to be inserted and retained in the cavity. The insert 22 is configured to have a fish attracting feature, where such feature is unique from the characteristics of the bait body 12. The fish attracting feature of the insert 22 may be configured to emit light waves, sound waves, a chemical attractant, or the like that is designed to be attracting to the target fish species. For example, the insert 22 may include a rattle, a glow stick or material, and/or a scented material, such as shown in additional examples illustrated in FIGS. 7-13.

As shown in FIG. 3, the head portion 14 and the tail portion 16 of the bait body 12 are divided at a longitudinal location on the bait body 12 typically associated with the gill location on a fish. In this minnow example, the head portion 14 is defined forward the portion of the bait body having the largest vertical thickness of the bait body 12 and the tail portion 16 is defined rearward the largest vertical thickness of the bait body 12. The rear end of the tail portion 16 includes a split caudal fin 28 that has an upper fin lobe and a lower fin lobe that are capable of simulating some action or movement of the lure as it is pulled through the water.

As also shown in FIG. 3, the bait body 12 can be defined to include an upper area 24 and a lower area 26 divided along a longitudinal axis A of the bait body 12. For example, the upper area 24 may have a vertical thickness that is greater than a diameter of the cavity 18. In other words, the mass of elastomeric material above the cavity 18 is greater than the interior volume of the cavity 18. As shown in FIGS. 1 and 3, the hook 30 may be pierced through the upper area 24 of the bait body 12 above the cavity 18, such as not to pierce or intersect the cavity 18 or the insert 22 contained therein. The hook 30 is shown pierced through the general eye area of the bait body 12 at the front end or head portion 14 of the bait body 12. The barbed tip of the hook 30 protrudes upward and out from the upper or dorsal surface of the bait body 12 and then curves back toward the front end of the bait body 12. The upper area 24 of the head portion 14 is configured to be a solid mass of the elastomeric material so as to provide a secure location for the hook to be retained and supported. It is also contemplated that a hook may be pierced through alternative locations on the bait body, such as through both the upper and lower areas of the bait body, among other conceivable piercing locations. It is also contemplated that hooks with different shapes from that illustrated in FIGS. 1 and 3 may be used with the bait body, such as for example smaller hooks, larger hooks, treble hooks, or the like.

The cavity 18 defined inside the bait body 12, as shown in FIG. 3, includes a bulbous section 32 toward the head portion 14 and a narrow section 34 between the bulbous section 32 and the opening 20 of the cavity. The narrow section 34 tapers in shape from the bulbous section 32 toward the opening 20. Since the bait body 12 is formed with an elastomeric material, the cavity 18 may expand from its static state to receive a relatively larger insert. Specifically, the narrow section 34 has a diameter in the static state that less than the diameter of the insert 22 and the diameter of the bulbous section 32. As such, the narrow section 34 may elastically expand from the static state when the insert 22 is inserted or removed from the cavity 18. The narrow section 34 also may elastically contract back to the static state to retain the insert 22 in the bulbous section 32 during use of the fishing lure. The cavity 18 is shown in FIGS. 1-3 extending longitudinally within the bait body 12, however, it may be angled or different configured in additional examples. For instance, the cavity may be more cylindrical or differently shaped to accommodate differently shaped or multiple inserts.

The examples of the bait body illustrated herein are molded in the shape of a minnow. However, additional examples of the bait body may be formed as a worm, a frog, or a crayfish, among various creatures or other body shapes. The elastomeric materials used to mold the bait body is a liquid plastisol that may be combined with various pigments, glitters, and/or powders to provide unique coloring patterns, such as to resemble live bait or otherwise attract the targeted fish species. The liquid plastisol is injected into a mold, such as a preformed metal mold in the desired shape. In addition, different polymers may be used, such as polyvinyl alcohol (PVOH), instead of polyvinyl chloride (PVC) that forms the liquid plastisol.

As shown in FIGS. 1-3, the insert 22 has an elongated cylindrical shape that, when inserted in the bait body 12, extends longitudinally within the cavity 18 in general parallel alignment with the longitudinal axis A of the bait body 12. In the illustrated examples herein, the insert 22 includes a rigid material with a higher durometer than the bait body, such that the stiffness of the insert 18 allows it to be more easily inserted and removed from the cavity 18 of the bait body 12. In additional examples, the insert may have different shapes and multiple inserts may be used with a single bait body.

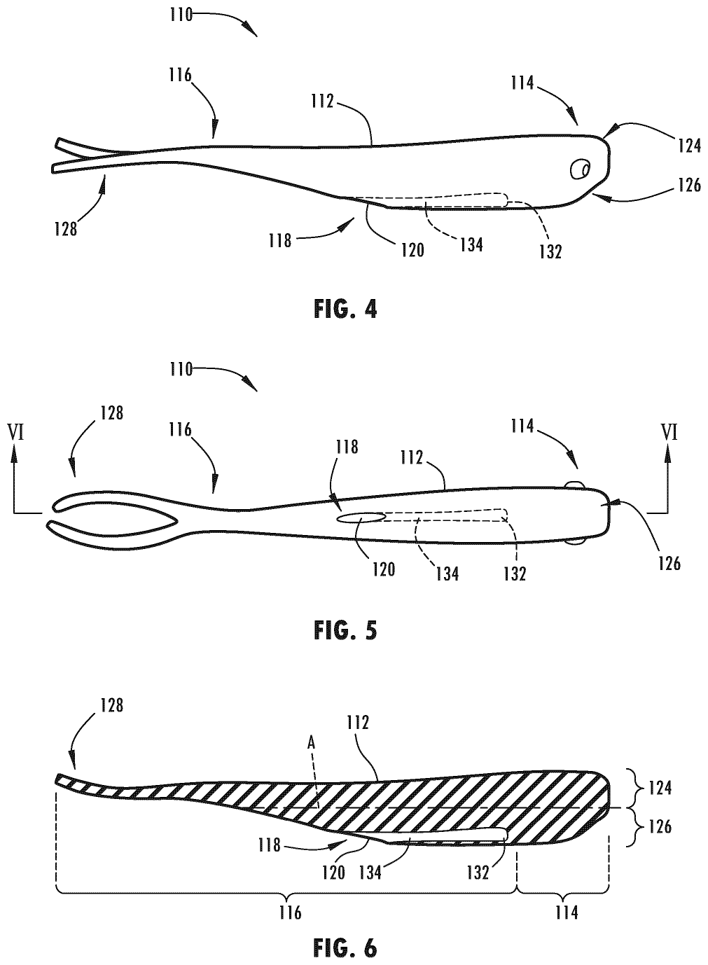

As shown in FIGS. 4-9, an additional example of a soft plastic lure 110 having a bait body 112 molded from an elastomeric material in the shape of a minnow with a head portion 114 and a tail portion 116 opposite the head portion 114. Similar reference numbers are provided in FIGS. 4-9 to those shown in FIGS. 1-3 incremented by 100 to represent like features. Like the example shown in FIGS. 1-3, the bait body 112 defines a cavity 118 that extends into the bait body 112 toward the head portion 114 and that has an opening 120 facing rearward and disposed generally at the tail portion 116. The head portion 114 is defined forward the portion of the bait body having the largest vertical thickness of the bait body 112 and the tail portion 116 is defined rearward the largest vertical thickness of the bait body 112. The rear end of the tail portion 116, however, includes a split caudal fin 128 that has a left fin lobe and a right fin lobe that are capable of simulating some action or movement of the lure as it is pulled through the water.

As shown in FIGS. 7 and 8, an insert 122 is configured to be inserted into the cavity 118 through the opening 120 and retained in the bait body 112. The insert 122 includes a rattle and is defined by a clear hard plastic housing that contains two metal balls or ball bearings. In additional examples, the rattle may include more or fewer metal balls or other rigid objects that are configured to rattle and generate and emit sound waves, which may attract certain fish species. A rattle insert may also include one or more additional fish attracting features in other examples.

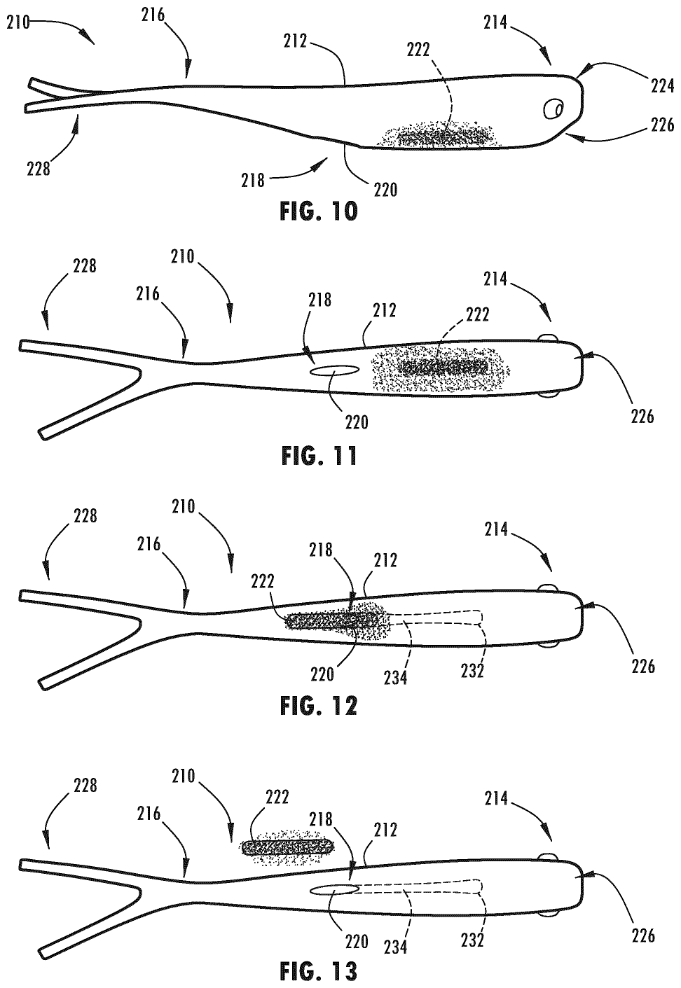

As shown in FIGS. 10-13, an additional example of a soft plastic lure 210 having a bait body 212 molded from an elastomeric material in the shape of a minnow is provided similarly to that illustrated in FIGS. 4-9. Similar reference numbers are provided in FIGS. 10-13 to those shown in FIGS. 4-9 incremented by 100 to represent like features. The lower area 226 of the bait body 212 is at least partially translucent or semi-translucent, so as to allow light emitted by the insert 222 to be visible through the elastomeric material of the bait body surrounding the cavity.

As also shown in FIGS. 10-13, an insert 222 is configured to be inserted into the cavity 218 through the opening 220 and retained in the bait body 212. The insert 222 includes a glow stick and is defined by a translucent plastic tube that contains luminescent material. More specifically, the translucent plastic tube contains isolated substances that, when combined, emit light through chemiluminescence. In additional examples, the glowing material may be disposed over the outer surface of the insert or the light may be emitted with other means, such as electro-luminescence. A glow stick insert may also include one or more additional fish attracting features in other examples.

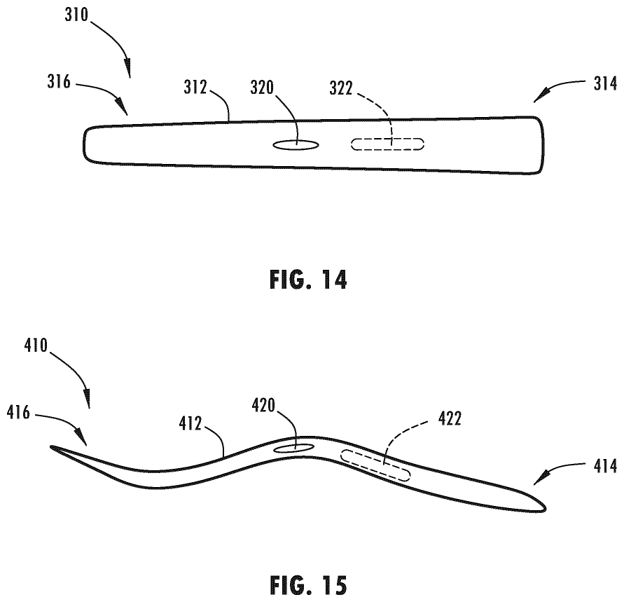

As shown in FIGS. 14 and 15, additional examples of soft plastic lures 310, 410 having a bait body molded from an elastomeric material in different shapes. The body shape of the soft plastic lure 310 shown in FIG. 14 has a non-anatomical shape, which may be referred to as a tube shape. The body shape of the soft plastic lure 410 shown in FIG. 15 has an anatomical shape of a worm. Similar reference numbers are provided in FIGS. 14 and 15 to those shown in FIGS. 10-13 incremented by 100 to represent like features.

The preformed cavity in the bait body is designed to receive a rigid insert with a fish attracting feature, which may be selected to be desirable for the angler's perceived fishing conditions. For example, the insert may include a rattle with the fish attracting feature being the emission of sound waves from the rattle. In another example, the insert may include a glow stick with the fish attracting feature being the emission of light waves from the glow stick. In yet another example, the insert may include a scented material with the fish attracting feature being the emission of the chemical attractant from the scented material. The angler may select a desirable insert and insert it in the cavity of the elastomeric bait body to customize the soft plastic fishing lure to target certain species of fish and/or accommodate different fishing environments.

For purposes of this disclosure, the term “coupled” (in all of its forms, couple, coupling, coupled, etc.) generally means the joining of two components directly or indirectly to one another. Such joining may be stationary in nature or movable in nature; may be achieved with the two components and any additional intermediate members being integrally formed as a single unitary body with one another or with the two components; and may be permanent in nature or may be removable or releasable in nature, unless otherwise stated.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional implementations that also incorporate the recited features. Furthermore, the terms “first,” “second,” and the like, as used herein do not denote any order, quantity, or importance, but rather are used to denote element from another.

Numbers, percentages, ratios, or other values stated herein are intended to include that value, and also other values that are “about” or “approximately” the stated value, as would be appreciated by one of ordinary skill in the art encompassed by implementations of the present disclosure. A stated value should therefore be interpreted broadly enough to encompass values that are at least close enough to the stated value to perform a desired function or achieve a desired result. For example, the terms “approximately,” “about,” and “substantially” may refer to an amount that is within less than 5% of, within less than 1% of, within less than 0.1% of, and within less than 0.01% of a stated amount.

Further, it should be understood that any directions or reference frames in the preceding description are merely relative directions or movements. For example, the terms “upper,” “lower,” “right,” “left,” “rear,” “front,” “vertical,” “horizontal,” and derivatives thereof shall relate to the orientation shown in FIG. 1. However, it is to be understood that various alternative orientations may be provided, except where expressly specified to the contrary. It is also to be understood that the specific devices and processes illustrated in the attached drawings, and described in this specification are simply exemplary embodiments of the inventive concepts defined in the appended claims. Hence, specific dimensions and other physical characteristics relating to the embodiments disclosed herein are not to be considered as limiting, unless the claims expressly state otherwise.

Changes and modifications in the specifically described embodiments may be carried out without departing from the principles of the present invention, which is intended to be limited only by the scope of the appended claims as interpreted according to the principles of patent law. The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

1. A soft plastic fishing lure comprising:
an elongated bait body comprising an elastomeric material and having an interior cavity with an opening extending from an exterior of the bait body into the interior cavity; and
an insert configured to be inserted into the interior cavity via the opening and retained in the bait body, wherein the insert has a fish attracting feature.

2. The soft plastic fishing lure of claim 1, wherein the fish attracting feature is configured to emit at least one of light waves, sound waves, or a chemical attractant.

3. The soft plastic fishing lure of claim 1, wherein the insert comprises at least one of a rattle, a glow stick, or a scented material.

4. The soft plastic fishing lure of claim 1, wherein the insert includes an elongated shape that, when inserted in the bait body, extends longitudinally within the interior cavity.

5. The soft plastic fishing lure of claim 1, wherein the insert includes a rigid material with a higher durometer than the bait body.

6. The soft plastic fishing lure of claim 1, wherein the bait body comprises a head portion and a tail portion located longitudinally relative to each other, and wherein the opening of the interior cavity extends into the bait body toward the head portion.

7. The soft plastic fishing lure of claim 6, wherein the interior cavity extends longitudinally within the bait body.

8. The soft plastic fishing lure of claim 7, wherein the interior cavity comprises a bulbous section toward the head portion of the bait body and a narrow section between the bulbous section and the opening of the interior cavity.

9. The soft plastic fishing lure of claim 1, wherein the bait body includes an upper area and a lower area divided along a longitudinal axis of the bait body, and wherein the upper area has a vertical thickness that is greater than a diameter of the interior cavity.

10. The soft plastic fishing lure of claim 9, further comprising a hook disposed in the upper area of the bait body above the interior cavity.

11. A soft plastic fishing lure comprising:
an elongated bait body comprising an elastomeric material,
the elongated bait body having a cavity disposed along a length of the elongated bait body with an opening extending from an exterior of the bait body into the cavity; and
an insert configured to be inserted into the cavity through the opening and retained in the bait body, wherein the insert has a fish attracting feature.

12. The soft plastic fishing lure of claim 11, wherein the insert comprises at least one of a rattle, a glow stick, or a scented material.

13. The soft plastic fishing lure of claim 11, wherein the insert includes a rigid material with a higher durometer than the bait body.

14. The soft plastic fishing lure of claim 11, wherein the insert includes an elongated shape that, when inserted in the bait body, extends longitudinally within the cavity.

15. The soft plastic fishing lure of claim 14, wherein the bait body comprises a head portion and a tail portion located longitudinally relative to each other, and wherein the opening of the cavity extends into the bait body toward the head portion.

16. The soft plastic fishing lure of claim 15, wherein the cavity comprises a bulbous section toward the head portion of the bait body and a narrow section between the bulbous section and the opening of the cavity.

17. The soft plastic fishing lure of claim 11, wherein the bait body includes an upper area and a lower area divided along a longitudinal axis of the bait body, and wherein the upper area has a vertical thickness configured to receive a hook above the cavity.

18. A soft plastic fishing lure comprising:
a bait body having a head portion and a tail portion opposite the head portion, the bait body comprising an elastomeric material,
the bait body defining a cavity with an opening disposed at the tail portion and extending into the bait body toward the head portion; and
an insert configured to be inserted into the cavity through the opening and retained in the bait body, wherein the insert has a fish attracting feature.

19. The soft plastic fishing lure of claim 18, wherein the fish attracting feature is configured to emit at least one of light waves, sound waves, or a chemical attractant.

20. The soft plastic fishing lure of claim 18, wherein the insert comprises at least one of a rattle, a glow stick, or a scented material.
